(19) United States
(12) Patent Application Publication
(10) Pub. No.: US 2024/0395019 A1
(43) Pub. Date: Nov. 28, 2024

(54) ARRAY-TYPE FACIAL BEAUTY PREDICTION METHOD, AND DEVICE AND STORAGE MEDIUM

(71) Applicant: WUYI UNIVERSITY, Jiangmen (CN)

(72) Inventors: Junying GAN, Jiangmen (CN); Xiaoshan XIE, Jiangmen (CN); Guohui HE, Jiangmen (CN)

(21) Appl. No.: 18/696,704

(22) PCT Filed: Feb. 28, 2023
(86) PCT No.: PCT/CN2023/078767

§ 371 Date: Mar. 28, 2024

(30) Foreign Application Priority Data
Aug. 1, 2022 (CN) 2022109165288

(51) Int. Cl. G06V 10/764; G06V 10/80; G06V 10/82; G06V 40/16

(52) U.S. Cl. CPC G06V 10/764; G06V 10/806; G06V 10/82; G06V 40/171

(57) ABSTRACT

An array-type facial beauty prediction method, a device and a storage medium are disclosed. The method includes: extracting a plurality of facial beauty features of different scales from a face image by means of a plurality of feature extractors; performing array-type fusion on the plurality of facial beauty features of different scales to obtain a plurality of fused features; performing binary classification processing on the plurality of fused features multiple times by means of a facial beauty classification network to obtain a plurality of classification results, where the facial beauty classification network is obtained by means of supervised training using a cost-sensitive loss function, and the cost-sensitive loss function is a loss function that is set according to cost-sensitive training labels; and making a decision on the basis of the plurality of classification results to obtain a facial beauty prediction result.

### CROSS-REFERENCE TO RELATED APPLICATIONS

This application is a national stage filing under 35 U.S.C. § 371 of international application number PCT/CN2023/078767, filed Feb. 28, 2023, which claims priority to Chinese patent application No. 2022109165288 filed Aug. 1, 2022. The contents of these applications are incorporated herein by reference in their entirety.

### TECHNICAL FIELD

The present disclosure relates to the field of image data processing, and in particular to an array-type facial beauty prediction method, a device and a storage medium.

### BACKGROUND

Facial beauty prediction involves the use of machine learning methods to intelligently predict the beauty level of different facial images based on their aesthetic features, thereby endowing machines with a human-like perception of facial beauty.

In related art, facial beauty prediction involves extracting features from facial images, performing tasks based on these features to make predictions, and obtaining prediction results. However, current facial beauty prediction methods suffer from insufficient feature extraction capabilities and lack of prediction accuracy.

### SUMMARY

The present disclosure aims to solve at least one of the technical problems in the existing technology. To this end, the present disclosure provides an array-type facial beauty prediction method, a device and a storage medium, having strong feature extraction capabilities and accurate facial beauty prediction results.

An embodiment of the first aspect of the present disclosure provides an array-type facial beauty prediction method, including:

extracting a plurality of facial beauty features of different scales from a face image by means of a plurality of feature extractors;

performing array-type fusion on the plurality of facial beauty features of different scales to obtain a plurality of fused features;

performing binary classification processing on the plurality of fused features multiple times by means of a facial beauty classification network to obtain a plurality of classification results, where the facial beauty classification network is obtained by means of supervised training using a cost-sensitive loss function, and the cost-sensitive loss function is a loss function that is set according to cost-sensitive training labels; and

making a decision on the basis of the plurality of classification results to obtain a facial beauty prediction result.

According to the above embodiment of the present disclosure, at least the following beneficial effects can be achieved. Extracting a plurality of facial beauty features of different scales from a face image by means of a plurality of feature extractors can effectively improve feature extraction capabilities, and provide comprehensive feature data for subsequent prediction work. Performing array-type fusion on the plurality of facial beauty features of different scales can strengthen the effect of information supervision, and improve the fitting performance of models. Meanwhile, optimizing the facial beauty classification network by means of a cost-sensitive loss function can effectively reduce the average cost of classification errors, and reduce the impact on the facial beauty classification network due to imbalanced data samples used for training, thereby improving the classification prediction effect. Making a decision on the classification results of all the binary classification tasks by means of ensembled decision-making can analyze the classification results of all the binary classification tasks to obtain the optimal facial beauty prediction result, thereby improving the accuracy of facial beauty prediction results.

According to some embodiments of the first aspect of the present disclosure, the extracting a plurality of facial beauty features of different scales from a face image by means of a plurality of feature extractors includes:

constructing three feature extractors respectively using a convolutional neural network, a width learning system, and a transformer model; and

performing feature extraction on the face image respectively by means of the three feature extractors to obtain facial beauty features of three different scales.

According to some embodiments of the first aspect of the present disclosure, the performing array-type fusion on the plurality of facial beauty features of different scales to obtain a plurality of fused features includes:

performing arrayed distribution on the facial beauty features of a plurality of scales to obtain a feature array; and

fusing every two facial beauty features in the feature array to obtain a plurality of fused features.

According to some embodiments of the first aspect of the present disclosure, after fusing every two facial beauty features in the feature array to obtain a plurality of fused features, the method further includes:

fusing the plurality of fused features to obtain a secondary fused feature, where the secondary fused feature is used to be input into the facial beauty classification network for binary classification processing, so as to obtain the corresponding classification results.

According to some embodiments of the first aspect of the present disclosure, the facial beauty classification network is trained by:

inputting a face training set into the facial beauty classification network, where the face training set includes a plurality of sets of corresponding face training images and beauty level training labels, and the beauty level training labels have a plurality of dimensions;

classifying face training images by each of the binary classification tasks in the facial beauty classification network to obtain classification training results; and

performing supervised training on each of the binary classification tasks according to each dimension in the beauty level training labels, and adjusting parameters of the binary classification tasks by means of the cost-sensitive loss function to obtain the trained facial beauty classification network.

According to some embodiments of the first aspect of the present disclosure, before performing supervised training on each of the binary classification tasks according to each dimension in the beauty level training labels, the method includes:

adjusting each of the binary classification tasks by means of joint debugging, allowing feature sharing between the binary classification tasks.

According to some embodiments of the first aspect of the present disclosure, the performing supervised training on each of the binary classification tasks according to each dimension in the beauty level training labels, and adjusting parameters of the binary classification tasks by means of the cost-sensitive loss function to obtain the trained facial beauty classification network includes:

when the face training set comprises difficult samples, remaining shared features between the binary classification tasks unchanged, performing supervised training on each of the binary classification tasks according to each dimension in the beauty level training labels, and adjusting parameters of the binary classification tasks by means of the cost-sensitive loss function to obtain the trained facial beauty classification network.

According to some embodiments of the first aspect of the present disclosure, a test is further performed after the facial beauty classification network is trained, and the facial beauty classification network is tested by:

inputting a face test set into the facial beauty classification network, where the face test set includes face test images and beauty level test labels;

performing error judgment on each of the classification results according to the beauty level test labels to obtain error results; and

correcting the corresponding binary classification tasks according to the error results to obtain the facial beauty classification network that has completed the test.

An embodiment of the second aspect of the present disclosure provides an electronic device, including:

a memory, a processor, and a computer program which is stored in the memory and executable on the processor, where the computer program, when executed by the processor, causes the processor to implement the array-type facial beauty prediction method of any one of embodiments of the first aspect.

Since the electronic device of the embodiment of the second aspect applies the array-type facial beauty prediction methods of any one of embodiments of the first aspect, the electronic device has all the beneficial effects of the first aspect of the present disclosure.

A computer storage medium is further provided according to an embodiment of the third aspect of the present disclosure, in which computer-executable instructions are stored, where the computer-executable instructions are used to execute the array-type facial beauty prediction method of any one of embodiments of the first aspect.

Since the computer storage medium of the embodiment of the third aspect can execute the array-type facial beauty prediction method of any one of embodiments of the first aspect, the computer storage medium has all the beneficial effects of the first aspect of the present disclosure.

Additional aspects and advantages of the present disclosure will be set forth in part in the description which follows, and in part will be obvious from the description, or may be learned by practice of the present disclosure.

### BRIEF DESCRIPTION OF DRAWINGS

The above and/or additional aspects and advantages of the present disclosure will become apparent and readily understood from the description of the embodiments taken in conjunction with the following accompanying drawings, in which:

FIG. 1 illustrates the main steps of an array-type facial beauty prediction method according to an embodiment of the present disclosure;

FIG. 2 illustrates the specific steps of step S100 in FIG. 1;

FIG. 3 illustrates the specific steps of step S200 in FIG. 1;

FIG. 4 illustrates the training steps of a facial beauty classification network in the array-type facial beauty prediction method according to an embodiment of the present disclosure;

FIG. 5 illustrates the testing steps of the facial beauty classification network in the array-type facial beauty prediction method according to an embodiment of the present disclosure; and

FIG. 6 illustrates the structural diagram of a facial beauty prediction network model corresponding to the array-type facial beauty prediction method according to an embodiment of the present disclosure.

### DETAILED DESCRIPTION

In the description of the present disclosure, unless otherwise explicitly limited, words such as setting, installation, and connection should be understood in a broad sense. Those of ordinary skills in the art can reasonably determine the specific meaning of the above words in the present disclosure in combination with the specific content of the technical solution. In the description of the present disclosure, several means one or more; a plurality of means two or more; greater than, less than, more than, etc. are understood to exclude the following number; and above, below, within, etc. are understood to include the following number. In addition, features defined with “first” and “second” may explicitly or implicitly include one or more of these features. In the description of the present disclosure, unless otherwise specified, “a plurality of” means two or more.

Facial beauty prediction and its learning represents a cutting-edge topic in the fields of computer vision. Facial beauty prediction involves the use of machine learning methods to intelligently predict the beauty level of different facial images based on their aesthetic features, thereby endowing machines with a human-like perception of facial beauty. Currently, facial beauty prediction faces problems such as insufficient supervision information, unbalanced data samples, and susceptibility to overfitting in models.

In related art, facial beauty prediction involves extracting features from facial images, performing tasks based on these features to make predictions, and obtaining prediction results. However, current facial beauty prediction methods suffer from insufficient feature extraction capabilities and lack of prediction accuracy.

Due to the lack of a large-scale and effective facial beauty database and the insufficient feature extraction capabilities of a network model used to extract features, facial beauty prediction has problems such as insufficient supervision information and model overfitting. In addition, when predicting facial beauty, the error rate or accuracy is usually used as an evaluation index, resulting in equal-cost prediction for each type of samples. However, in reality, the cost of misjudging one type of samples as another is different. For example, in cancer diagnosis, predicting a cancer patient to be healthy will cause the patient to miss the best treatment time, which is obviously different from the cost of predicting a healthy person to be a cancer patient.

Therefore, in the process of model building, it is necessary to focus not only on the accuracy of the results, but also on the average cost in prediction errors. In the field of facial beauty prediction, since the number of ordinary people in reality is much larger than the number of extremely attractive and extremely unattractive, which will lead to an imbalance in the data samples used for training. Classifiers work well when used to classify categories corresponding to the majority of sample data, but poorly when used to classify categories corresponding to the minority of sample data.

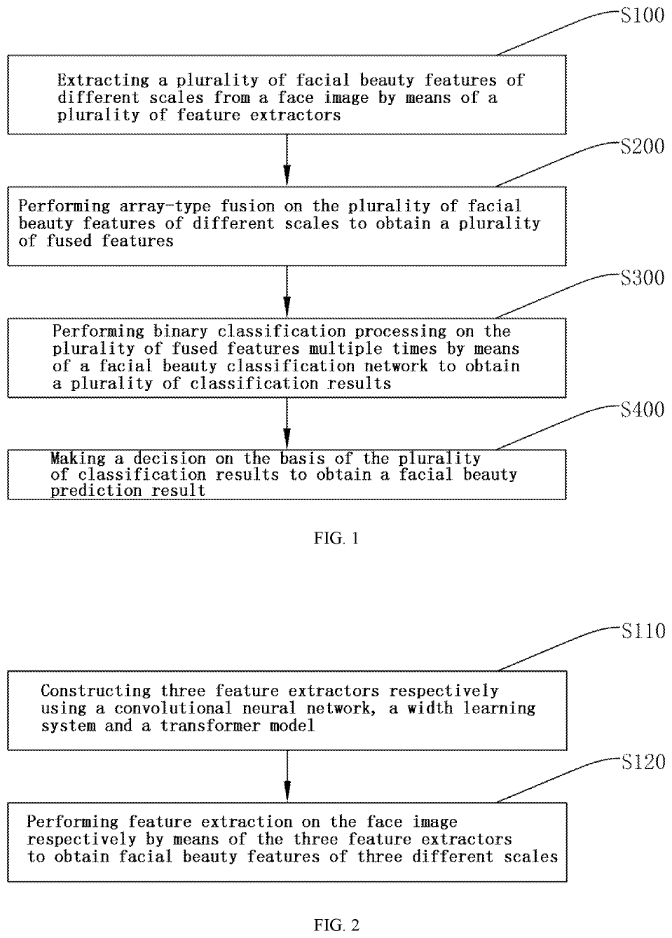

With reference to FIGS. 1 to 6, the following describes an array-type facial beauty prediction method, a device and a storage medium of the present disclosure, having strong feature extraction capabilities, accurate facial beauty prediction results, and good prediction effects.

Referring to FIG. 1, an array-type facial beauty prediction method according to an embodiment of the first aspect of the present disclosure includes but is not limited to the following steps:

S100: extracting a plurality of facial beauty features of different scales from a face image by means of a plurality of feature extractors;

S200: performing array-type fusion on the plurality of facial beauty features of different scales to obtain a plurality of fused features;

S300: performing binary classification processing on the plurality of fused features multiple times by means of a facial beauty classification network to obtain a plurality of classification results, where the facial beauty classification network is obtained by means of supervised training using a cost-sensitive loss function, the cost-sensitive loss function is a loss function that is set according to cost-sensitive training labels, and the cost-sensitive function is used to minimize the average cost when an error occurs in the classification results; and

S400: making a decision on the basis of the plurality of classification results to obtain a facial beauty prediction result, where ensembled decision-making is used to ensemble the plurality of classification results to make decisions, thereby obtaining the facial beauty prediction result.

Extracting facial beauty features of a plurality of scales from a face image by means of a plurality of feature extractors can effectively improve feature extraction capabilities, and provide comprehensive feature data for subsequent prediction work. Performing array-type fusion on the facial beauty features of different scales can strengthen the effect of information supervision, and improve the fitting performance of models. Meanwhile, optimizing the facial beauty classification network by means of a cost-sensitive loss function can effectively reduce the average cost of classification errors, and reduce the impact on the facial beauty classification network due to imbalanced data samples used for training, thereby improving the classification prediction effect. Making a decision on the classification results of all the binary classification tasks by means of ensembled decision-making can analyze the classification results of all the binary classification tasks to obtain the optimal facial beauty prediction result, thereby improving the accuracy of facial beauty prediction results.

It should be noted that the ensembled decision-making can be set to vote on each classification result and output the final facial beauty prediction result.

It can be understood that, referring to FIG. 2, the step S100 of extracting a plurality of facial beauty features of different scales from a face image by means of a plurality of feature extractors includes but is not limited to the following steps:

S110: constructing three feature extractors respectively using a convolutional neural network, a width learning system and a transformer model; and

S120: performing feature extraction on the face image respectively by means of the three feature extractors to obtain facial beauty features of three different scales.

It should be noted that in addition to constructing three feature extractors using a convolutional neural network, a width learning system and a transformer model, a corresponding number of feature extractors can also be constructed using other different network models for feature extraction of different scales on the face image, so as to improve feature extraction capabilities, which can enhance the effect of information supervision and reduce the probability of model overfitting and other problems. The convolutional neural network is a type of feed-forward neural networks that contain convolutional calculations and have a deep structure, and is one of the representative algorithms of deep learning. The width learning system is a neural network structure that does not rely on deep structures and have no coupling between layers, making them very concise. The transformer model is a self-attention network modeler.

It can be understood that, referring to FIG. 3, the step S200 of performing array-type fusion on the plurality of facial beauty features of different scales to obtain a plurality of fused features includes but is not limited to the following steps:

S210: performing arrayed distribution on the facial beauty features of a plurality of scales to obtain a feature array; and

S220: fusing every two facial beauty features in the feature array to obtain a plurality of fused features, where the aforementioned feature fusion is fusing the facial beauty features in the feature array in pairs, and when the facial beauty features arranged in an array are fused, the array-type feature fusion can be facilitated.

The facial beauty features are distributed in an array, and the feature array is as follows:

$$\\ {F}_{1} = ξ ( x )$$

$$\\ {F}_{2} = ψ ( x )$$

$$\\ {F}_{3} = θ ( x )$$

where x represents the face image, ξ represents the feature extraction function of the convolutional neural network, ψ represents the feature extraction function provided by width learning, θ represents the feature extraction function of the transformer model, and F₁, F₂ and F₃ represent the facial beauty features of corresponding scales, respectively.

It can be understood that after the step S200, that is, after fusing every two facial beauty features in the feature array to obtain a plurality of fused features, the method further includes but is not limited to the following steps:

S230: fusing the plurality of fused features to obtain a secondary fused feature, where the secondary fused feature is used to be input into the facial beauty classification network for binary classification processing, so as to obtain the corresponding classification results.

The facial beauty features are fused to obtain a plurality of fused features, and all the fused features are fused to obtain a secondary fused feature. All the fused features and the secondary fused feature are expressed as follows:

$$\\ {F}_{a} = {F}_{1} + {F}_{2}$$

$$\\ {F}_{b} = {F}_{1} + {F}_{3}$$

$$\\ {F}_{c} = {F}_{2} + {F}_{3}$$

$$\\ {F}_{sum} = {F}_{a} + {F}_{b} + {F}_{c}$$

where Fₐ, F_{b} and F_{c} respectively represent the fused features obtained after the three facial beauty features are fused in pairs, and Fₛᵤₘ represents the secondary fused feature after all the fused features are fused.

It can be understood that the facial beauty classification network uses both the fused features and the secondary fused feature to perform facial beauty classification. Performing array-type fusion on the facial beauty features of a plurality of scales, and inputting the fused features into the facial beauty classification network for classification prediction can effectively solve the problems of insufficient supervision information and susceptibility to overfitting in models in facial beauty prediction.

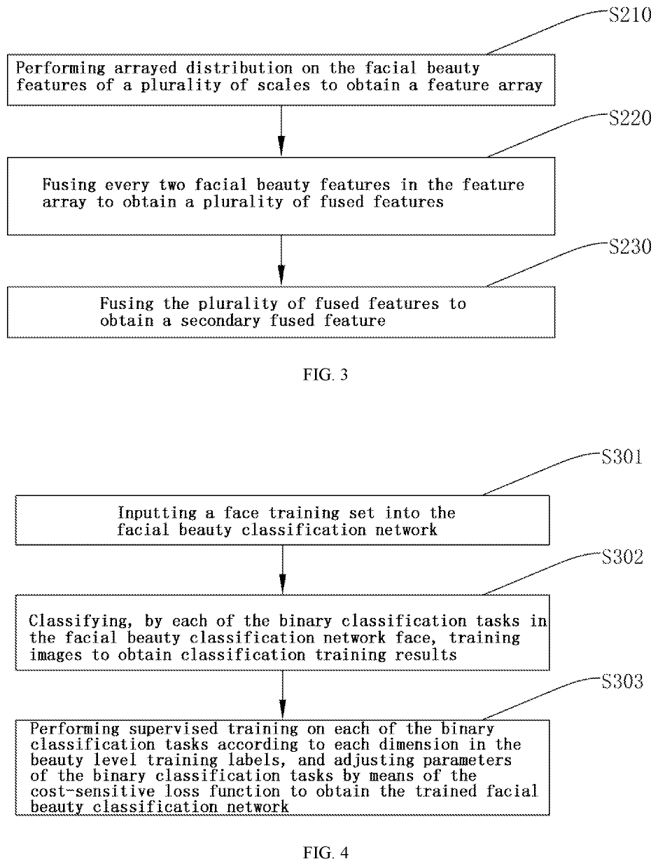

It can be understood that, with reference to FIG. 4, a training method for the facial beauty classification network includes but is not limited to the following steps:

S301: inputting a face training set into the facial beauty classification network, where the face training set includes a plurality of sets of corresponding face training images and beauty level training labels, and the beauty level training labels have a plurality of dimensions;

S302: classifying, by each of the binary classification tasks in the facial beauty classification network face, training images to obtain classification training results, where the binary classification tasks are used to perform corresponding binary classification processing; and

S303: performing supervised training on each of the binary classification tasks according to each dimension in the beauty level training labels, and adjusting parameters of the binary classification tasks by means of the cost-sensitive loss function to obtain the trained facial beauty classification network.

Inputting the face training set into the facial beauty classification network for training, and supervising the training of the facial beauty classification network by means of the cost-sensitive loss function can obtain the trained facial beauty classification network.

It should be noted that, during the training process of the facial beauty classification network,

$$\\ {D}_{test} = {\{ {X}_{i}^{{}_{} test} \}}_{i = 1}^{{N}_{test}}$$

is set to represent the test set, and there are a total of Nₜₑₛₜ test samples; and

$$\\ {D}_{train} = {\{ {X}_{i}^{{}_{} train} , {y}_{i} \}}_{i = 1}^{{N}_{train}}$$

is set to represent the training set, yᵢ∈{1, 2, 3, . . . . K}, and there are a total of Nₜᵣₐᵢₙ training samples, where Xᵢ^{train} represents the ith face training image, and yᵢ represents the beauty level training label of the ith training sample and is used to represent the facial beauty level label of this training sample. There are K levels in total. The label of the kth dimension of the ith face training image is expressed as:

$$\\ {y}_{i}^{{}_{} ( k )} = \{ \begin{matrix}1 , k < {y}_{i} \\ 0 , k \geq {y}_{i}\end{matrix} where {y}_{i} ∈ {R}^{{}_{} K - 1} , k ∈ \{ 1 , 2 , 3 … K - 1 \} .$$

The above sorting formula is used to redefine yᵢ as a K−1 dimensional vector, and each dimension in the K−1 dimensional vector in yᵢ as a label, so that K−1 Boolean labels are generated for the ith face training image Xᵢ^{train}. Assuming that there are K−1 tasks in the face classification network and the tasks are all binary classification tasks, the K−1 labels of Xᵢ^{train} in the ith face training image can be used to supervise the above K−1 binary classification tasks, which can successfully transform the facial beauty classification tasks into a plurality of binary classification tasks.

It should be further noted that the cost-sensitive loss function introduces cost sensitivity into the loss function. The cost formula defined by yᵢ^{(k)} is expressed as:

$$\\ {cost}_{{}_{} k} ( {y}_{i} ) = \{ \begin{matrix}k - {y}_{i} + 1 , {y}_{i} \leq k \\ {y}_{i} - k , {y}_{i} > k\end{matrix}$$

where k∈{1, 2, 3 . . . . K−1}, after the facial beauty classification tasks are transformed into K−1 binary classification tasks, the cost-sensitive loss function is introduced in each binary classification task. The cost-sensitive loss function of the Kth binary classification task is expressed as:

$$\\ {L}_{k} = - {cost}_{k} ( {y}_{i} ) {y}_{i}^{{}_{} ( k )} log σ ( {W}^{{}_{} {( k )}^{{}_{} T}} {X}_{i} ) + ( 1 - {y}_{i}^{{}_{} ( k )} ) log ( 1 - σ ( {W}^{{}_{} {( k )}^{{}_{} T}} {X}_{i} ) )$$

where W^{(k)} represents the parameters of shared features and task k, and σ(x) represents the relu function. The cost-sensitive loss function of the above binary classification tasks indicates that the greater the degree of error, the higher the cost required, and the cost for correct classification is 0. The above cost-sensitive loss function is used to perform supervised training on the binary classification tasks.

It can be understood that before performing supervised training on each binary classification task according to each dimension in the beauty level training labels, the method includes but is not limited to the following steps:

adjusting each of the binary classification tasks by means of joint debugging, allowing feature sharing between the binary classification tasks.

A convolutional neural network can be used to extract shared features from the input fused features and secondary fused feature, and each of the binary classification tasks can use the shared features for classifying.

Specifically, joint debugging involves transforming the facial beauty classification tasks into K−1 binary classification tasks, and then training and fine-tuning the facial beauty classification network in the order from 1 to K−1. In the manner of joint debugging, the probability of negative transfer between different binary classification tasks is reduced. Since the features focused on by the same binary classification task are similar, joint debugging enables the sharing of features between different tasks, and debugging and optimizing the binary classification tasks by means of a backpropagation algorithm can form shared features between the binary classification tasks.

By splitting the facial beauty classification tasks into a plurality of binary classification tasks for joint debugging and optimization, not only can the correlation between the binary classification tasks be preserved in the form of shared features, but each of the binary classification task is more specialized, allowing the improvement of the generalization performance of the facial beauty classification network. Moreover, the use of shared features for facial beauty classification can avoid negative transfer and excessive network structure in order to take into account a plurality of data. By introducing cost sensitivity into the loss function, the problem of sample imbalance in the face training set can be effectively solved, and the accuracy of facial beauty prediction can be improved.

It can be understood that the performing supervised training on each of the binary classification tasks according to each dimension in the beauty level training labels, and adjusting parameters of the binary classification tasks by means of the cost-sensitive loss function to obtain the trained facial beauty classification network includes but is not limited to the following steps:

when the face training set comprises difficult samples, remaining shared features between the binary classification tasks unchanged, performing supervised training on each of the binary classification tasks according to each dimension in the beauty level training labels, and adjusting parameters of the binary classification tasks by means of the cost-sensitive loss function to obtain the trained facial beauty classification network, where the difficult samples represent training samples with conflicting output results for K−1 binary classification tasks.

By means of introducing the processing of difficult samples, the facial beauty classification network can be forced to learn deeper features. The binary classification tasks are fine-tuned by means of the difficult samples, the shared features remain unchanged and only the parameters of the binary classification tasks are changed, which can reduce the probability of overfitting. Meanwhile, the representation ability and generalization ability of the facial beauty classification network are improved.

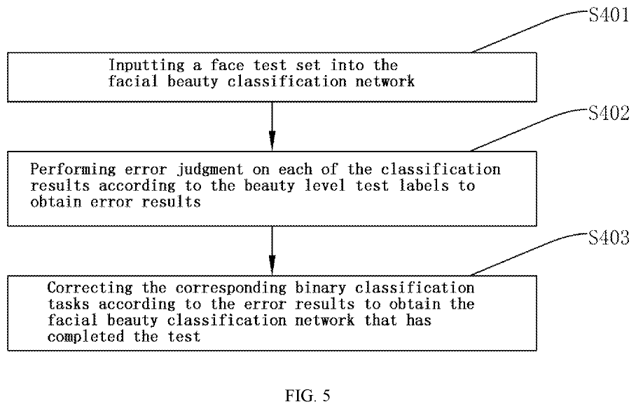

It can be understood that, with reference to FIG. 5, a test is further performed after the facial beauty classification network is trained, and a test method for the facial beauty classification network includes but is not limited to the following steps:

S401: inputting a face test set into the facial beauty classification network, where the face test set includes face test images and beauty level test labels;

S402: performing error judgment on each of the classification results according to the beauty level test labels to obtain error results; and

S403: correcting the corresponding binary classification tasks according to the error results to obtain the facial beauty classification network that has completed the test.

In the test phase, an ensembled decision-making method is used to correct errors in a single binary classification task. The classification results of a plurality of binary classification tasks are comprehensively considered to determine the final facial beauty prediction result, which can improve the accuracy and robustness of decision-making.

It should be noted that the ensembled decision-making involves voting on the classification results of K−1 binary classification tasks, and finally outputting the facial beauty prediction result. Assuming that the errors of each binary classification task are equally likely, when the result does not belong to any of the labels, the one with the least errors in the binary classification tasks is used as the standard, that is, assuming that some binary classifiers have classification errors, the corresponding binary classification tasks are corrected in the way corresponding to the binary classification tasks with the least changes, so as to obtain the facial beauty classification network that has completed the test. When a bottleneck occurs, that is, when the number of binary classification tasks that need to be changed is the same, the confidence between the binary classification tasks that need to be changed needs to be compared, and the binary classification tasks with a lower confidence are determined to have errors, that is, the binary classification tasks with the lower confidence are corrected to obtain the facial beauty classification network that has completed the test, thereby solving the bottleneck problem.

Specifically, taking quadruple classification as an example, the classification results of all the binary classification tasks are ensembled into the form of a vector. If a test label appears to be [0, 1,0], a decision is made by taking the above ensembled decision-making as the criteria. If there is an error in a binary classification task, resulting in the result being [0,0,0] or [1,1,0], there is a need at this time to compare the confidence of the first binary classification task and that of the second binary classification task, and the binary classification task with a lower confidence is selected for correction. For example, if the confidence of the first binary classification task is lower, the first binary classification task is corrected so that 1 in its classification result is corrected to 0, and the facial beauty classification network that has completed the test is obtained.

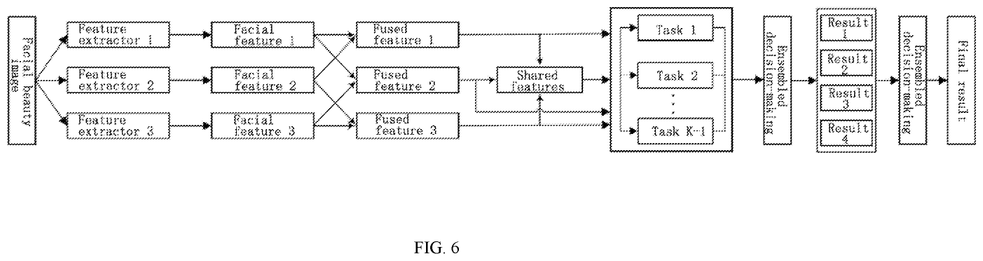

FIG. 6 shows the structure of the facial beauty prediction network model corresponding to the array-type facial beauty prediction method. The following describes an array-type facial beauty prediction method according to an embodiment of the first aspect of the present disclosure with reference to FIG. 6.

A feature extractor 1, a feature extractor 2 and a feature extractor 3 are constructed respectively using a convolutional neural network, a width learning system and a transformer model, the feature extractors are used to extract facial features of different scales, that is, facial beauty features.

A facial feature 1, a facial feature 2 and a facial feature 3 of different scales are fused in pairs to obtain a fused feature 1, a fused feature 2 and a fused feature 3.

The fused feature 1, fused feature 2 and fused feature 3 are input into the facial beauty classification model, where the facial beauty classification tasks of the facial beauty classification network are split into a plurality of binary classification tasks, namely a task 1, a task 2, . . . a task K−1, respectively, which are optimized by means of multi-task predictive learning and joint debugging, and three classification results are obtained by means of ensembled decision-making, namely a result 1, a result 2 and a result 3, respectively. The result 1, result 2 and result 3 are fused and then input into the facial beauty classification model to obtain another classification result as a result 4.

By voting on the result 1, result 2, result 3 and result 4 by means of ensembled decision-making, the final facial beauty prediction result is obtained as the final result in FIG. 6.

In addition, an embodiment of the second aspect of the present disclosure further provides an electronic device, including: a memory, a processor, and a computer program which is stored in the memory and executable on the processor.

The processor and the memory may be connected via a bus or other means.

As a non-transitory computer-readable storage medium, the memory can be used to store non-transitory software programs and non-transitory computer-executable programs. In addition, the memory may include a high-speed random access memory and may also include a non-transitory memory, such as at least one magnetic disk storage device, a flash memory device, or other non-transitory solid-state storage devices. In some embodiments, the memory optionally includes memories located remotely from the processor, and these remote memories may be connected to the processor via networks. Examples of the above networks include but are not limited to the Internet, intranets, local area networks, mobile communication networks and combinations thereof.

The non-transient software programs and instructions required to implement the array-type facial beauty prediction method in the above embodiment of the first aspect are stored in the memory. When executed by the processor, the array-type facial beauty prediction method in the above embodiment is executed, for example, the above-described method steps S100 to S400, method steps S110 to S120, method steps S210 and S220, method step 230, method steps S301 to S303, and method steps S401 to S403 are performed.

The device embodiments described above are merely illustrative. The units described as separate components may or may not be physically separate, that is, the units may be located in one place, or may be distributed across a plurality of network units. Some or all of the modules can be selected according to actual needs to achieve the purpose of the solution of the embodiments.

In addition, an embodiment of the third aspect of the present disclosure provides a computer-readable storage medium that stores computer-executable instructions, and the computer-executable instructions are executed by a processor or a controller, for example, by a processor in the above device embodiments, allowing the above processor to execute the array-type facial beauty prediction method in the above embodiment, for example, to execute the above-described method steps S100 to S400, method steps S110 to S120, method steps S210 and S220, method step 230, method steps S301 to S303, and method steps S401 to S403.

Those of ordinary skill in the art can understand that all or some steps in the methods, and the systems disclosed above can be implemented as software, firmware, hardware, and appropriate combinations thereof. Some or all of the physical components may be implemented as software executed by a processor, such as a central processing unit, a digital signal processor, or a microprocessor, or as hardware, or as an ensembled circuit, such as an application specific integrated circuit. Such software may be distributed on computer-readable media, which may include computer storage media (or non-transitory media) and communication media (or transitory media). As is known to those of ordinary skill in the art, the term computer storage media includes volatile and non-volatile, removable and non-removable media implemented in any method or technique for storing information (such as computer-readable instructions, data structures, program modules or other data). Computer storage media include, but are not limited to, RAM, ROM, EEPROM, flash memory or other memory technology, CD-ROM, Digital Versatile Disk (DVD) or other optical disk storage, magnetic cassettes, tapes, disk storage or other magnetic storage devices, or any other media that may be used to store the desired information and can be accessed by a computer. Additionally, it is known to those of ordinary skill in the art that communication media typically embody computer-readable instructions, data structures, program modules or other data in a modulated data signal such as a carrier wave or other transport mechanism, and may include any information delivery media.

In the description of this specification, description with reference to the terms such as “an embodiment”, “some embodiments”, “illustrative embodiments”, “examples”, “specific examples”, or “some examples” implies that specific characteristics, structures, materials or features described in conjunction with the embodiments or examples are included in at least one embodiment or example of the present disclosure. In this specification, the schematic expression of the above terms does not necessarily refer to the same embodiment or example. Moreover, the specific characteristics, structures, materials or features described can be combined in any one or more embodiments or examples in a suitable manner.

Although the embodiments of the present disclosure have been shown and described, a person of ordinary skill in the art may understand that various changes, modifications, substitutions and variations can also be made to these embodiments without departing from the principle and purpose of the present disclosure, and the scope of the present disclosure is defined by the claims and their equivalents.

1. An array-type facial beauty prediction method, comprising:
extracting a plurality of facial beauty features of different scales from a face image by means of a plurality of feature extractors;
performing array-type fusion on the plurality of facial beauty features of different scales to obtain a plurality of fused features;
performing binary classification processing on the plurality of fused features multiple times by means of a facial beauty classification network to obtain a plurality of classification results, wherein the facial beauty classification network is obtained by means of supervised training using a cost-sensitive loss function, and the cost-sensitive loss function is a loss function that is set according to cost-sensitive training labels; and
making a decision on the basis of the plurality of classification results to obtain a facial beauty prediction result.

2. The array-type facial beauty prediction method according to claim 1, wherein the extracting a plurality of facial beauty features of different scales from a face image by means of a plurality of feature extractors comprises:
constructing three feature extractors respectively using a convolutional neural network, a width learning system and a transformer model; and
performing feature extraction on the face image respectively by means of the three feature extractors to obtain facial beauty features of three different scales.

3. The array-type facial beauty prediction method according to claim 1, wherein the performing array-type fusion on the plurality of facial beauty features of different scales to obtain a plurality of fused features comprises:
performing arrayed distribution on the facial beauty features of a plurality of scales to obtain a feature array; and
fusing every two facial beauty features in the feature array to obtain a plurality of fused features.

4. The array-type facial beauty prediction method according to claim 3, wherein, after fusing every two facial beauty features in the feature array to obtain a plurality of fused features, the method further comprises:
fusing the plurality of fused features to obtain a secondary fused feature, wherein the secondary fused feature is used to be input into the facial beauty classification network for binary classification processing, so as to obtain the corresponding classification results.

5. The array-type facial beauty prediction method according to claim 1, wherein the facial beauty classification network is trained by:
inputting a face training set into the facial beauty classification network, wherein the face training set comprises a plurality of sets of corresponding face training images and beauty level training labels, and the beauty level training labels have a plurality of dimensions;
classifying face training images by each of the binary classification tasks in the facial beauty classification network to obtain classification training results; and
performing supervised training on each of the binary classification tasks according to each dimension in the beauty level training labels, and adjusting parameters of the binary classification tasks by means of the cost-sensitive loss function to obtain the trained facial beauty classification network.

6. The array-type facial beauty prediction method according to claim 5, wherein before performing supervised training on each of the binary classification tasks according to each dimension in the beauty level training labels, the method comprises:
adjusting each of the binary classification tasks by means of joint debugging, allowing feature sharing between the binary classification tasks.

7. The array-type facial beauty prediction method according to claim 6, wherein the performing supervised training on each of the binary classification tasks according to each dimension in the beauty level training labels, and adjusting parameters of the binary classification tasks by means of the cost-sensitive loss function to obtain the trained facial beauty classification network comprises:
when the face training set comprises difficult samples, remaining shared features between the binary classification tasks unchanged, performing supervised training on each of the binary classification tasks according to each dimension in the beauty level training labels, and adjusting parameters of the binary classification tasks by means of the cost-sensitive loss function to obtain the trained facial beauty classification network.

8. The array-type facial beauty prediction method according to claim 5, wherein a test is further performed after the facial beauty classification network is trained, and the facial beauty classification network is tested by:
inputting a face test set into the facial beauty classification network, wherein the face test set comprises face test images and beauty level test labels;
performing error judgment on each of the classification results according to the beauty level test labels to obtain error results; and
correcting the corresponding binary classification tasks according to the error results to obtain the facial beauty classification network that has completed the test.

9. An electronic device, comprising:
a memory, a processor, and a computer program that is stored in the memory and executable on the processor, where the computer program, when executed by the processor, causes the processor to implement the array-type facial beauty prediction method of claim 1.

10. A non-transitory computer storage medium, storing computer-executable instructions, the computer-executable instructions being used to execute the array-type facial beauty prediction method of claim 1.
